(19) United States
(12) Patent Application Publication
(10) Pub. No.: US 2026/0132807 A1
(43) Pub. Date: May 14, 2026

(54) Fastener

(71) Applicant: Illinois Tool Works Inc., Glenview, IL (US)

(72) Inventors: Logan Scott Irvine, Chippewa Falls, WI (US); David William Edland, Chippewa Falls, WI (US); Jeremy Paul Berres, Chippewa Falls, WI (US)

(21) Appl. No.: 19/382,482

(22) Filed: Nov. 7, 2025

Related U.S. Application Data
(60) Provisional application No. 63/719,191, filed on Nov. 12, 2024.

(51) Int. Cl. F16B 5/06; F16B 21/07

(52) U.S. Cl. CPC F16B 5/065; F16B 21/073

(57) ABSTRACT

Disclosed is a plastic fastener for coupling a first component to a second component. The fastener includes a body portion, a pair of tower legs, and at least one mating feature. The body portion extends along a longitudinal axis and defining a first end and a second end. The pair of tower legs extend from the body portion at the second end, each tower leg being resiliently deflectable relative to the longitudinal axis. The at least one mating feature positioned on an inward-facing surface of each tower leg and configured to engage a corresponding seating portion of a rib tower of the second component. The mating feature is configured to facilitate insertion of the rib tower between the pair of tower legs and to resiliently engage the seating portion to mechanically retain the fastener to the rib tower.

### RELATED APPLICATIONS

The present application claims priority to U.S. Provisional Patent Application No. 63/719,191, filed Nov. 12, 2024, and entitled “Riblok for Metal,” which is hereby incorporated by reference in its entirety.

### BACKGROUND

Automotive components require fastening techniques that are simple to manufacture and assemble. Further, fastening techniques should above all be reliable and efficient. In order to secure a secondary panel to a primary panel, a fastener may be used, such as a pin and grommet fastener.

Various types of fasteners are used for fastening components. For example, in the case of an instrument panel of a vehicle, fasteners may be used to fix together adjacent panels or to secure one or more objects on the panels. One such type of fasteners is usable with holes of different types, sizes, and shapes provided in the components to be secured together. In other words, for such a fastener to fasten the components, at least one of the components is provided with a hole. One of the components is mounted on the fastener and the other component having the hole receives the fastener component assembly.

Therefore, despite various advancements to date, it would nevertheless be desirable to provide a plastic fastener that can be used with metal, for example.

### SUMMARY

The present disclosure relates generally to a fastening system to form a blind connection between the panels, such as automotive panels, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates an isometric assembly view of a fastening system in accordance with an aspect of this disclosure.

FIGS. 2a through 2c illustrate side views of the fastening system in different stages of assembly.

FIG. 2d illustrates a side cross-sectional view of the fastening system in an assembled position taken along cut line A-A as shown in FIG. 1.

FIGS. 3a through 3c illustrate, respectively, top side, first underside, and second underside isometric views of the fastener.

FIG. 3d illustrates a side elevation view of the fastener.

FIGS. 3e and 3f illustrate front and rear side elevation views of the fastener.

FIGS. 3g and 3h illustrate, respectively, topside and underside plan views of the fastener.

FIGS. 4a and 4b illustrate isometric cross-sectional views of the fastener, taken along cut lines B-B and C-C as shown in FIGS. 3e and 3g, respectively.

FIG. 4c illustrates a cross-sectional top plan view of the fastener, taken along cut line C-C as shown in FIG. 3e.

FIG. 4d illustrates a cross-sectional front elevation view of the fastener, taken along cut line D-D as shown in FIG. 3g.

### DESCRIPTION

References to items in the singular should be understood to include items in the plural, and vice versa, unless explicitly stated otherwise or clear from the text. Grammatical conjunctions are configured to express any and all disjunctive and conjunctive combinations of conjoined clauses, sentences, words, and the like, unless otherwise stated or clear from the context. Recitation of ranges of values herein are not configured to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

In one aspect, a fastener is provided for coupling a first component and a second component. The fastener includes a body portion extending along a longitudinal axis and defining a first end and a second end. A pair of tower legs extends from the body portion at the second end, with each tower leg being resiliently deflectable relative to the longitudinal axis. At least one mating feature is positioned on an inward-facing surface of each tower leg and is configured to engage a corresponding seating portion of a rib tower associated with the second component. The mating feature facilitates insertion of the rib tower between the pair of tower legs and resiliently engages the seating portion to mechanically retain the fastener to the rib tower.

In certain aspects, each mating feature may comprise a generally wedge-shaped projection having a sloped leading surface that guides the rib tower during insertion. The wedge-shaped projection may further define a trailing surface configured to engage an edge of the seating portion to resist withdrawal of the fastener once installed.

The fastener may further include at least one locking projection disposed on an outward-facing surface of each tower leg. Each locking projection can engage an edge of an opening formed in the first component when the fastener is installed therethrough. In some implementations, the locking projection extends outwardly from the tower leg in a direction substantially perpendicular to the longitudinal axis and is configured to deflect inward during insertion through the opening.

In various aspects, the tower legs are joined by a bridge located at the second end of the body portion. The bridge provides structural support and contributes to the resiliency of the tower legs during insertion. The bridge may also be dimensioned to enhance flexibility of the tower legs while preventing breakage or fatigue during repeated insertion and removal cycles.

A head portion may be connected to the body portion at the first end of the fastener. The head portion can include a plurality of cantilevered arms joined by a connecting element. In certain configurations, the connecting element includes a wing feature extending outwardly from the longitudinal axis to provide a manual engagement surface that facilitates handling or installation.

In some aspects, the tower legs and the mating features are integrally formed as a single molded unit. The fastener may be formed of a polymeric material—for example, a synthetic or semi-synthetic polymer—selected to provide sufficient elasticity for repeated insertion and removal cycles without permanent deformation.

The mating features and locking projections may be arranged on opposite sides of each tower leg to provide dual engagement functions. The tower legs can also be biased toward one another to provide a self-centering action during engagement with the rib tower. When the fastener is installed, the trailing surface of each mating feature may be oriented substantially perpendicular to the longitudinal axis, enhancing retention.

The mating features and locking projections cooperate to secure the fastener simultaneously to both the rib tower of the second component and the first component. Engagement of the mating features with the seating portion inhibits forward withdrawal of the fastener from the rib tower, while engagement of the locking projections with the first component inhibits rearward withdrawal from the opening.

In another aspect, a fastener assembly is provided. The assembly includes the fastener described above, a rib tower forming part of a second component, and a first component defining an opening for receiving the fastener. The rib tower includes a seating portion configured to receive and engage the mating features of the fastener. The fastener mechanically couples the first and second components together through engagement of the mating features with the rib tower and engagement of the locking projections with the first component.

In certain aspects of the assembly, the fastener is formed of a synthetic polymer or semi-synthetic polymer, such as nylon or acetal. In yet another aspect, the fastener may be formed entirely of plastic, with the body portion, tower legs, and mating features molded as a single continuous piece. The plastic fastener may include a body portion extending along a longitudinal axis, a pair of resiliently deflectable tower legs extending from one end, and inward-facing mating features configured to engage the seating portion of a rib tower. The mating features facilitate insertion of the rib tower between the tower legs and resiliently engage the seating portion to mechanically retain the plastic fastener to the rib tower.

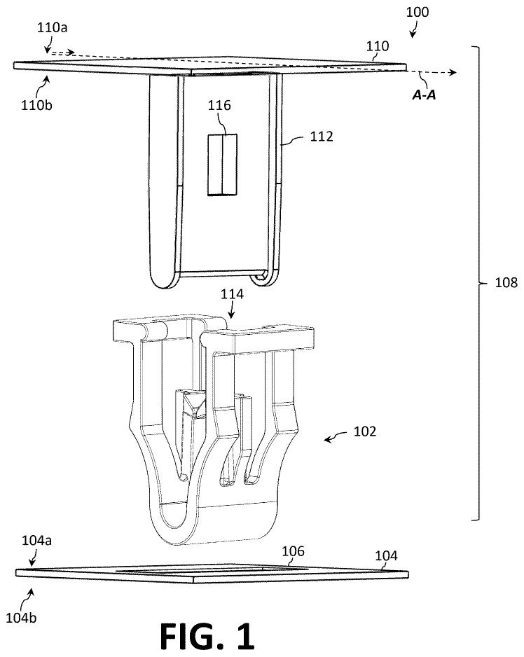

FIG. 1 illustrates an isometric assembly view of a fastening system 100 in accordance with an aspect of this disclosure. The illustrated fastening system 100 comprises a fastener 102 configured to connect a first component 104 to a second component 110 via a rib tower 112 associated with the second component 110. The fastener 102 facilitates a connection between the first component 104 and the second component 110. The first component 104 and the second component 110 may be, for example, automotive panels.

The first component 104, the second component 110, and the rib tower 112 can be manufactured from materials such as metals, synthetic or semi-synthetic polymers (e.g., acrylonitrile butadiene styrene (ABS), polyvinyl chloride (PVC)), composite materials (e.g., fiberglass), or combinations thereof. In automotive applications, these panels may include door trim panels, moldings, trim pieces, hoods, doors, pillars (e.g., A-pillar, B-pillar, C-pillar), dashboard components (e.g., cross members, brackets, frames), seat frames, center consoles, fenders, sheet metal frameworks, and other substrates used for interior or exterior surfaces.

The first component 104 comprises one or more openings 106, while the second component 110 includes one or more rib towers 112 having, for example, a seating portion 116 (e.g., a window, opening, hole, or the like). Each opening 106 is configured to receive or engage the fastener 102 and its corresponding rib tower 112. The fastener 102 and its corresponding rib tower 112 can be provided as a part-in-assembly (PIA) component 108. The rib towers 112 are configured to engage the fasteners 102 via, for example, features of the fasteners 102 and the seating portion 116. The first component 104 defines an A-surface 104a and a B-surface 104b (undersurface), and similarly, the second component 110 defines an A-surface 110a and a B-surface 110b (undersurface). The A-surface 104a of the first component 104 is the outward-facing surface, while the B-surface 104b is the inward-facing surface. Upon assembly, the A-surface 104a of the first component 104 faces the B-surface 110b of the second component 110.

The A-surface 110a, also known as a class A surface, remains visible post-assembly and is often aesthetically enhanced (e.g., textured, coated, or decorated) and typically free from attachment devices or related features. In contrast, the B-surface 110b, or class B surface, is concealed after assembly and usually incorporates various attachment devices or related features. For example, in a vehicle's instrument panel, the second component 110 could be a dashboard, and the first component 104 could be an instrument cluster mounted onto the dashboard, or vice versa.

The second component 110 may incorporate attachment devices or features such as the rib towers 112, which protrude from the B-surface 110b. Each rib tower 112 is generally perpendicular to a surface (e.g., a planar surface) of the second component 110 and may include the seating portion 116, whether a slot, window, or otherwise, which is configured to receive or otherwise engage a portion of the fastener 102. The rib towers 112 can be integral with the second component 110 (e.g., co-molded) or attached separately (e.g., using adhesive).

The fastener 102 can be secured onto the rib tower 112 of the second component 110, forming a part-in-assembly (PIA) component 108. For example, the fastener 102 defines a clip channel 114 that is configured to receive at least a portion of the rib tower 112 (e.g., starting at a leading end of the rib tower 112). The PIA component 108 can then be attached to the first component 104 by an end-user. In some scenarios, the PIA component 108 is preassembled at the factory and shipped to the end-user for final assembly with the first component 104.

In some examples, the fastener 102 is configured to be more ergonomic during insertion into the opening 106 of the first component 104, for example, requiring a relatively low insertion force. During separation or withdrawal from the opening 106, however, the fastener 102 may necessitate a considerably higher force compared to insertion. In other words, the fastener 102 is configured to have a low insertion force but a relatively high separation force. Notably, the insertion and separation forces are independent of each other.

The fastener 102 may be constructed from a generally rigid material, such as plastic. The fastener 102 may be fabricated from a polymeric material—whether synthetic or semi-synthetic polymers. For instance, the plastic material may include polypropylene (PP), acrylonitrile butadiene styrene (ABS), polycarbonate (PC), polymethyl methacrylate (PMMA), polyoxymethylene (POM), or a combination thereof. Notably, the fastener 102 can be fabricated from plastic while remaining suitable for use with metal components. Therefore, in one example, the fastener 102 is made from plastic, while the first component 104 and/or the second component 110 are metal, plastic, composite, or similar materials.

The fastener 102 can be formed via a plastic injection molding process. In other examples, the fastener 102 may be a printed thermoplastic component formed via additive manufacturing techniques, which are advantageous for creating complex or detailed features. Additive manufacturing techniques eliminate the need for mold tooling associated with plastic injection molding, reducing initial manufacturing costs—especially beneficial for low-volume production. Example additive manufacturing processes include material extrusion (e.g., fused deposition modeling (FDM)), stereolithography (SLA), selective laser sintering (SLS), material jetting, binder jetting, powder bed fusion, directed energy deposition, and vat photopolymerization.

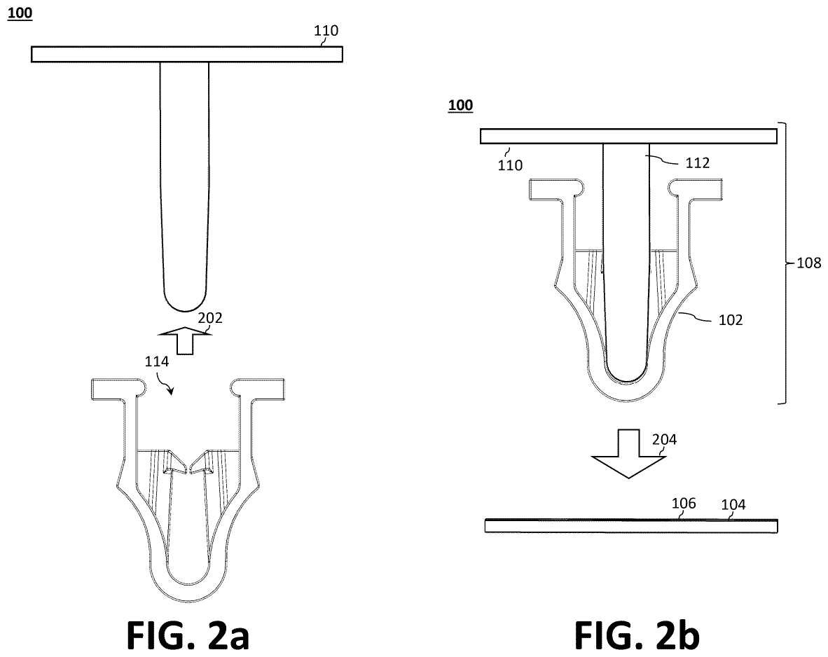

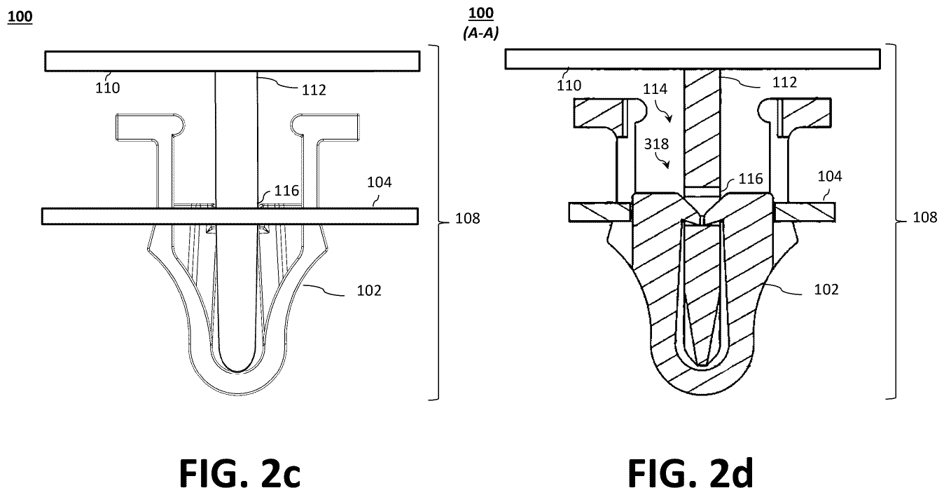

FIGS. 2a through 2c illustrate side views of the fastening system 100 in different stages of assembly, while FIG. 2d illustrates a side cross-sectional view of the fastening system 100 in an assembled position taken along cut line A-A as shown in FIG. 1. Specifically, FIG. 2a illustrates the second component 110 with a fastener 102 being slipped onto the rib tower 112 of the second component 110 as indicated by arrow 202 to define the PIA component 108, while FIG. 2b illustrates the fastener 102 and rib tower 112 of the assembled PIA component 108 being at least partially inserted into the opening 106 of the first component 104 as indicated by arrow 204. FIG. 2c illustrates the PIA component 108 fully assembled with the first component 104, while FIG. 2d illustrates a cross-sectional view thereof to show the interaction between the fastener 102 and rib tower 112 (e.g., at the seating portion 116).

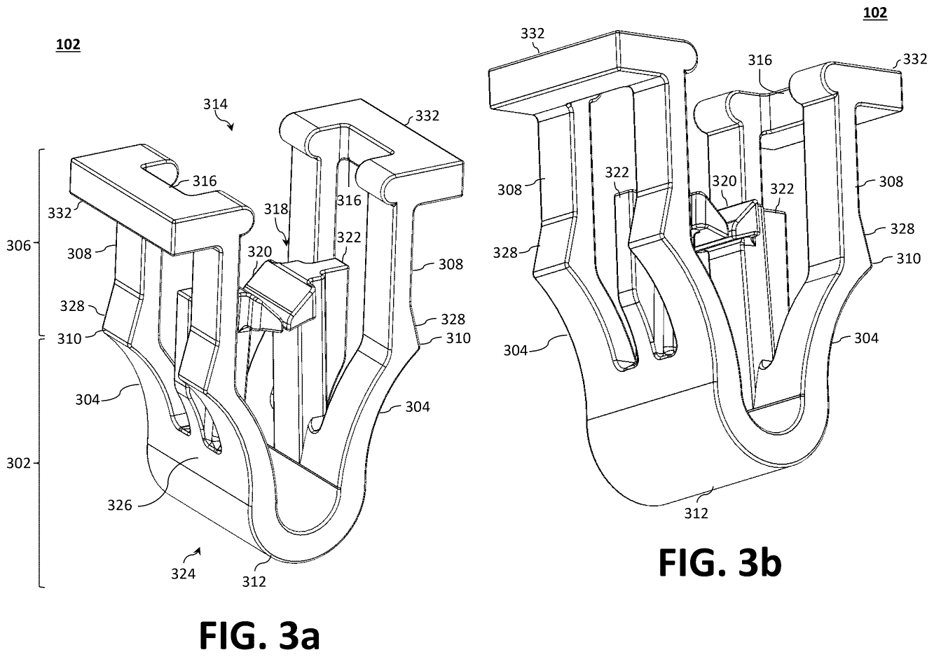

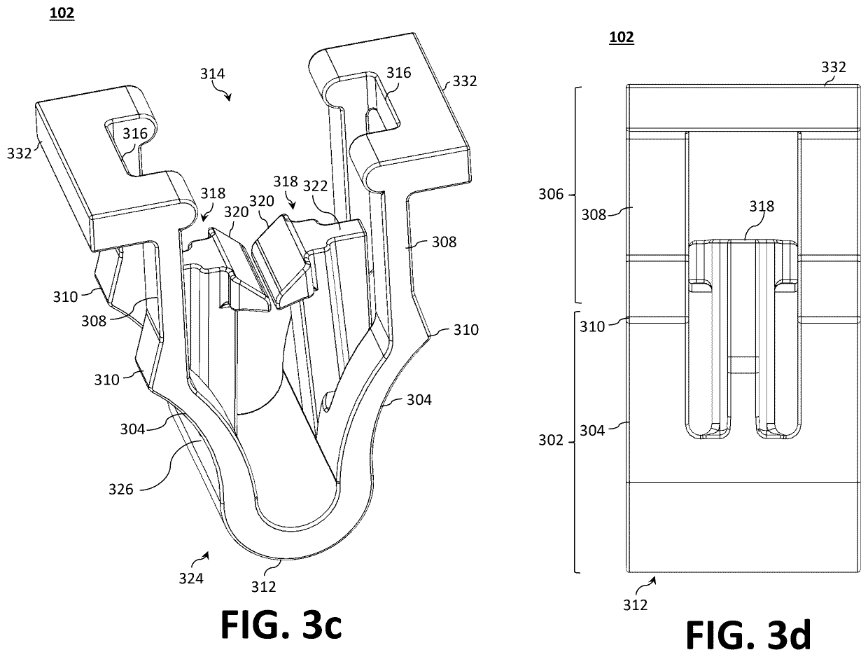

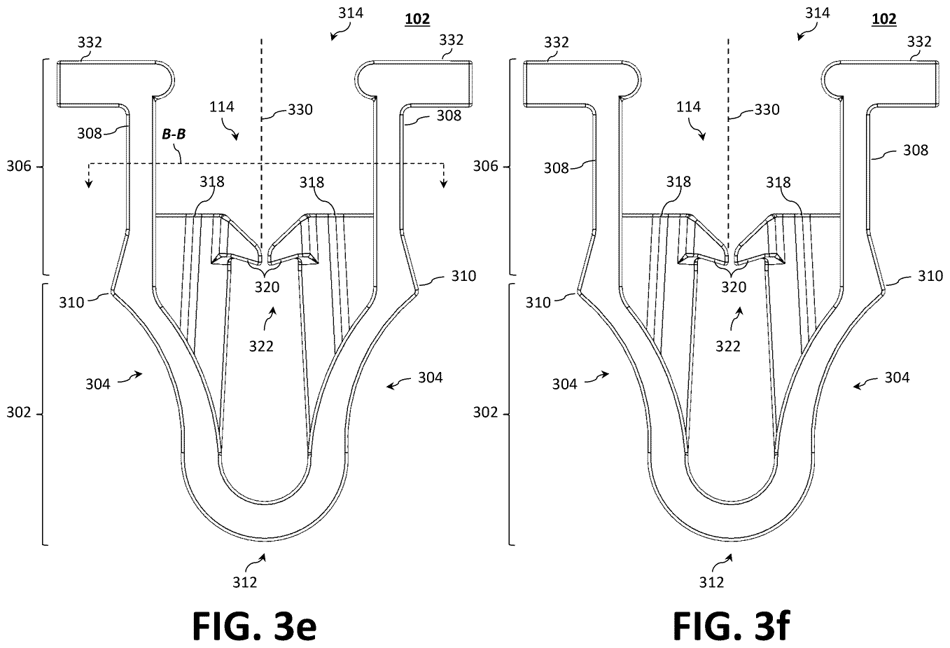

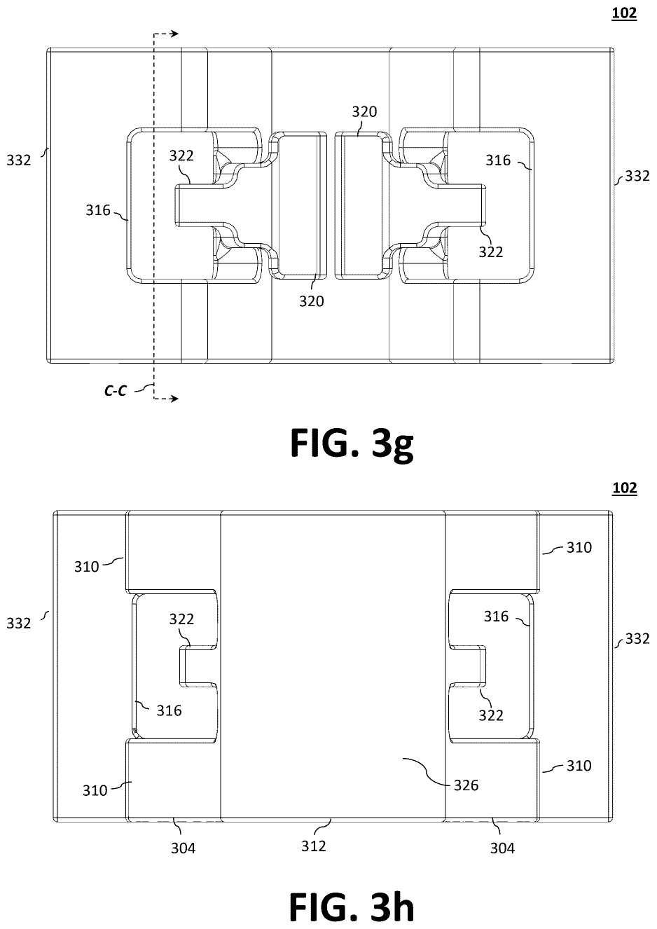

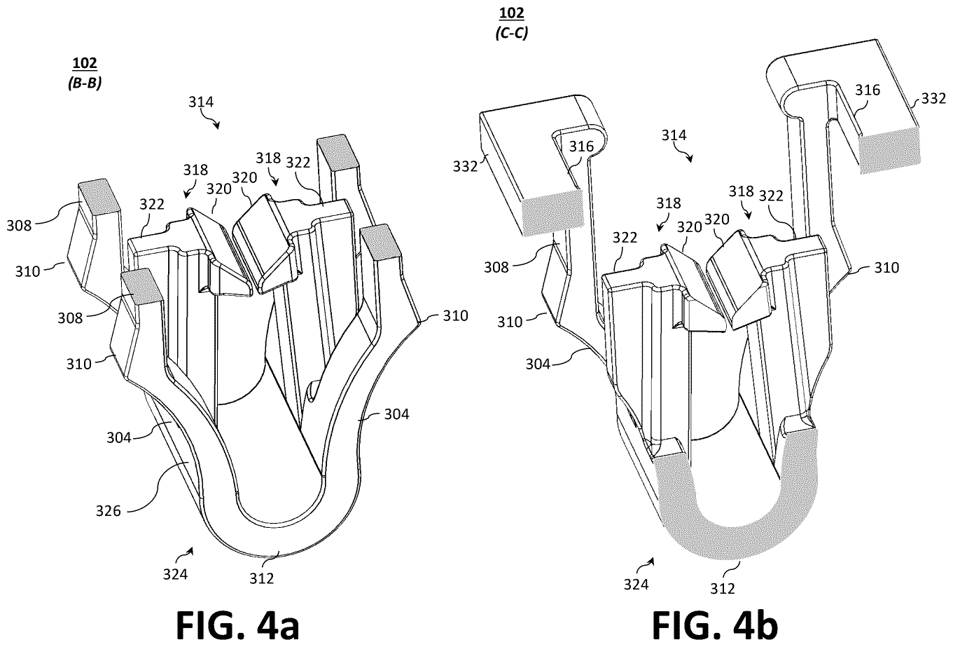

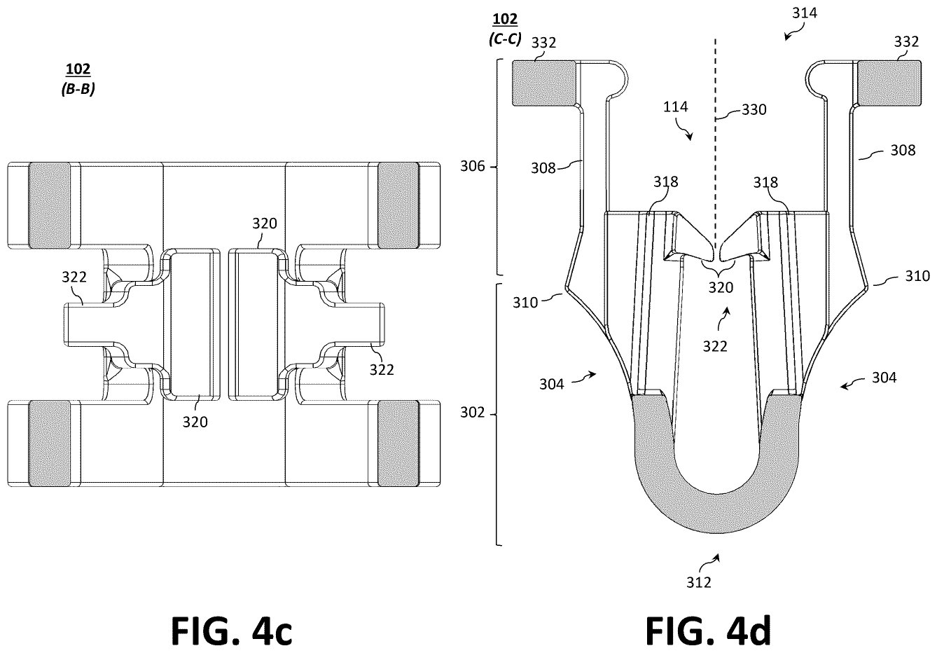

FIGS. 3a through 3h illustrate detailed views of the fastener 102 of FIGS. 1 and 2a through 2d. Specifically, FIGS. 3 a through 3 c illustrate, respectively, top-side, first-underside, and second-underside isometric views of the fastener 102. FIG. 3d illustrates a side elevation view of the fastener 102. FIGS. 3e and 3f illustrate front and rear elevation views of the fastener 102. FIGS. 3g and 3h illustrate, respectively, top-side and underside plan views of the fastener 102. Further, FIGS. 4a through 4d illustrate cross-sectional views to better depict certain portions of the fastener 102. Specifically, FIGS. 4a and 4b illustrate isometric cross-sectional views of the fastener 102, taken along cut lines B-B and C-C as shown in FIGS. 3e and 3g, respectively. FIG. 4c illustrates a cross-sectional top plan view of the fastener 102, taken along cut line C-C as shown in FIG. 3e, while FIG. 4d illustrates a cross-sectional front elevation view of the fastener 102, taken along cut line D-D as shown in FIG. 3g.

The fastener 102 generally comprises a body portion 302 and a head portion 306 that collectively define a first end 314 and a second end 324. As can be appreciated from the example images, the body portion 302 and the head portion 306 can be a unitary structure (i.e., single, integrated component). The body portion 302 comprises a plurality of ribs 304. As illustrated, the plurality of ribs 304 are arranged as two sets of parallel ribs 304 joined at one end via a bend section 312 at the leading end (e.g., the second end 324) to create the clip channel 114 with a generally U-shaped or V-shaped profile when viewed from the side, as best illustrated in FIGS. 3e and 3f (though other shape are contemplated). The bend section 312 defines the second end 324, which is opposite the first end 314.

Extending from the body portion 302 is the head portion 306, which includes a plurality of arms 308. Each arm 308 is connected to a free end of a rib 304 and extends away from the body portion 302 (i.e., away from the second end 324 and toward the first end 314). The arms 308 can be generally linear (e.g., straight sections). As illustrated, the plurality of arms 308 are arranged as two sets of parallel arms 308 (corresponding to and extending from the two sets of parallel ribs 304) that are joined at one end via a connecting element 316 at the trailing end (e.g., the first end 314). The arms 308 are arranged at their connection points 310 to form an angle relative to the ribs 304, allowing them to hinge or flex at the junction between the arm 308 and the rib 304. The illustrated rib 304 have a curved profile. The connecting element 316 is positioned at the first end 314 of the fastener 102. In the illustrated example, the connecting element 316 is positioned at the ledge 328.

Thus, the fastener 102 includes two connecting elements 316 at the first end 314, one on each side of the bend section 312. Each connecting element 316 comprises a wing feature 332 that extends away from the axis 330. In other words, the illustrated connecting element 316 is shaped to define a wing feature 332 at its distal end that extends outwardly from the fastener 102. In operation, the engagement features 332 can be used by the user to grasp the fastener 102 (e.g., during installation or removal from a rib tower 112) or to engage the first component 104 and/or the second component 110. For example, the engagement features 332 can be configured to prevent the fastener 102 from passing entirely through the opening 106, thus serving as a stop.

At the second end 324 of the fastener 102, i.e., at the bend section 312, the ribs 304 are joined by a bridge 326. The bridge 326 is configured to couple the ribs 304 while retaining flexibility during insertion into the opening 106. In some examples, the ribs 304 are tapered along their length to enhance flexibility without compromising strength, allowing the ribs 304 to bend during insertion into the opening 106 and then return to their original span without failure.

The fastener 102 further comprises a plurality of tower legs 318 for attachment to the second component 110—for example, a pair of tower legs 318. In one example, at least one tower leg 318 is provided on each side of the axis 330. As illustrated, the tower legs 318 are supported by the bridge 326 resiliently at the second end 324. In the illustrated fastener 102, each tower leg 318 is positioned between a pair of ribs 304, as illustrated in, for example, FIG. 3d.

Each of the pair of tower legs 318 includes a mating feature 320 configured to directly contact a corresponding surface of the rib tower 112 and to mechanically engage the seating portion 116 thereof. In certain embodiments, the mating feature 320 is integrally formed with the corresponding tower leg 318 and extends inwardly therefrom toward the opposing clip arm. The illustrated mating feature 320 is generally triangular or wedge-shaped in profile and includes a sloped leading surface and an oppositely oriented trailing surface. The sloped leading surface (i.e., the surface facing generally toward a central portion of the fastener body) is configured to facilitate insertion of the rib tower 112 between the pair of tower legs 318 during assembly, thus encouraging self-alignment and self-centering of the rib tower 112 relative to the fastener 102. The trailing surface of the mating feature 320 is comparatively flatter (e.g., perpendicular to or at a slight angle as illustrated, such as 5 to 15 degrees relative to the axis 330) and is oriented to engage an edge or boundary surface of the seating portion 116 once the fastener 102 is fully installed.

During assembly, the rib tower 112 is advanced between the pair of tower legs 318, causing the respective mating features 320 to slide along the outer surfaces of the rib tower 112. The resiliency of the tower legs 318 permits outward deflection as the mating features 320 traverse the tower surfaces. Upon alignment of the mating features 320 with the seating portion 116, the bias of the tower legs 318 causes the mating features 320 to snap or otherwise resiliently return inward, seating within the seating portion 116 to form a mechanical engagement between the fastener 102 and the rib tower 112. In this seated configuration, the trailing surface of each mating feature 320 abuts the corresponding edge of the seating portion 116 to prevent unwanted withdrawal of the fastener 102 from the rib tower 112, thereby providing enhanced retention and resistance to disengagement under pullout or vibration loads.

Each of the pair of tower legs 318 further includes a locking projection 322 configured to contact and mechanically interface with an edge of the opening 106 formed in the first component 104. The locking projections 322 are positioned on outward-facing portions of the tower legs 318, generally opposite the mating features 320, and are configured to engage the material surrounding the opening 106 when the fastener 102 is installed through the first component 104. In certain embodiments, each locking projection 322 is integrally formed with its corresponding tower leg 318 and extends outwardly therefrom in a direction generally perpendicular to the longitudinal axis of the tower leg 318 and toward the perimeter of the opening 106.

During insertion of the fastener 102 through the opening 106, the locking projections 322 deflect slightly inward via the tower legs 318 to permit passage through the opening 106. Once the fastener 102 is fully seated and the tower legs 318 have returned to their natural, unbiased position, the locking projections 322 move into interference with the rear surface or edge of the opening 106, as best illustrated in FIG. 2d. In this engaged condition, the locking projections 322 operate to inhibit removal of the fastener 102 from the rib tower 112 by resisting rearward movement of the tower legs 318. The locking projections 322 serve to prevent disengagement of the fastener 102 from the rib tower 112 during extraction or under pullout loads, thereby maintaining a secure coupling between the fastener 102, the first component 104, and the rib tower 112.

Once the fastener 102 is mounted onto the second component 110 (e.g., via the rib tower 112), the assembly of the fastener 102 and the second component 110 can be inserted into the opening 106 of the first component 104, thereby joining the first component 104 and the second component 110. For example, the fastener 102 can be inserted into the opening 106 of the first component 104 with the second end 324 entering first, as indicated by arrow 204 in FIG. 2b. The second end 324 is tapered and/or chamfered to facilitate insertion of the fastener 102 into the opening 106 of the first component 104.

The fastener 102 is engineered to consider both the insertion force required to insert it into the opening 106 and the separation force needed for its removal. In one aspect, the fastener 102 is configured so that the insertion force does not influence the separation force, and vice versa. For example, the fastener 102 may necessitate a nominal insertion force for user ergonomics while simultaneously requiring a significantly higher separation force compared to the insertion force.

In certain aspects, the bridge 326 is dimensioned to be compact, increasing the flexibility of the ribs 304 at the bend section 312, thereby reducing the insertion force needed to insert the fastener 102 into the second component 110. Additionally, the size of the bridge 326 is determined to prevent failure or breakage of the fastener 102 during insertion and withdrawal cycles (e.g., five or more). That is, the disclosed fastener 102 allows for the use of a short set-up height fasteners that are made from plastic, but used where one or both components (e.g., the first component 104 and/or second component 110 are metal—such as a metal mating panel condition). The part retains a degree of retention even after multiple removals and installations. Thus, the dimensions of the bridge 326 are optimized based on a balance between insertion force and structural integrity of the fastener 102. Consequently, the material selection for the fastener 102 also influences the sizing of the bridge 326, considering the aforementioned factors.

The design (e.g., shape) of the ribs 304 further affects the insertion force. To enhance their flexibility without compromising strength, the ribs 304 may feature a tapered shape along their length. Increased flexibility of the ribs 304 allows the fastener 102 to require only a nominal insertion force, enabling the ribs 304 to bend during entry into the opening 106 and subsequently return to their original shape without failure.

In some aspects, features of the fastener 102 are tailored based on the required separation force—the force necessary to withdraw the fastener 102 from the first component 104. For instance, the fastener 102 may be configured to withstand a separation force of at least 130 newtons (N), while the insertion force remains below approximately 45 N. These values are exemplary and not limiting; depending on design and application, the nominal insertion and separation forces may vary beyond the specified ranges.

While the present method and/or system has been described with reference to certain implementations, it will be understood by those skilled in the art that various changes may be made and equivalents may be substituted without departing from the scope of the present method and/or system. Therefore, although examples for fasteners have been described in language specific to structural features and/or methods, it is to be understood that the appended claims are not limited to the specific features described. Rather, the specific features are disclosed as examples of fasteners. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed:

1. A fastener for coupling a first component and a second component, the fastener comprising:
a body portion extending along a longitudinal axis and defining a first end and a second end;
a pair of tower legs extending from the body portion at the second end, each tower leg being resiliently deflectable relative to the longitudinal axis; and
at least one mating feature positioned on an inward-facing surface of each tower leg and configured to engage a corresponding seating portion of a rib tower of the second component,
wherein the mating feature is configured to facilitate insertion of the rib tower between the pair of tower legs and to resiliently engage the seating portion to mechanically retain the fastener to the rib tower.

2. The fastener of claim 1, wherein each mating feature comprises a generally wedge-shaped projection having a sloped leading surface configured to guide the rib tower during insertion.

3. The fastener of claim 2, wherein the generally wedge-shaped projection further defines a trailing surface configured to engage an edge of the seating portion to resist withdrawal.

4. The fastener of claim 1, further comprising at least one locking projection disposed on an outward-facing surface of each tower leg.

5. The fastener of claim 4, wherein each locking projection is configured to engage an edge of an opening formed in the first component when the fastener is installed therethrough.

6. The fastener of claim 4, wherein each locking projection extends outwardly from the tower leg in a direction substantially perpendicular to the longitudinal axis and is configured to deflect inward during insertion.

7. The fastener of claim 1, wherein the tower legs are coupled by a bridge at the second end of the body portion, the bridge providing structural support and resiliency during insertion.

8. The fastener of claim 7, wherein the bridge is dimensioned to enhance flexibility of the tower legs while preventing breakage during repeated insertion and removal cycles.

9. The fastener of claim 1, further comprising a head portion connected to the body portion at the first end, the head portion including a plurality of cantilevered arms joined by a connecting element.

10. The fastener of claim 9, wherein the connecting element includes a wing feature extending outwardly from the longitudinal axis to provide a manual engagement surface.

11. The fastener of claim 1, wherein the tower legs and the mating features are integrally formed as a single molded unit.

12. The fastener of claim 1, wherein the fastener is formed of a polymeric material.

13. The fastener of claim 1, wherein the mating features and the locking projections are positioned on opposite sides of each tower leg.

14. The fastener of claim 1, wherein the tower legs are biased toward one another to provide a self-centering action during engagement with the rib tower.

15. The fastener of claim 1, wherein the trailing surface of each mating feature is oriented substantially perpendicular to the longitudinal axis when the fastener is in an installed position.

16. The fastener of claim 1, wherein the mating features and the locking projections cooperate to secure the fastener simultaneously to the rib tower of the second component and to the first component.

17. The fastener of claim 16, wherein engagement of the mating features with the seating portion inhibits forward withdrawal of the fastener from the rib tower, and engagement of the locking projections with the first component inhibits rearward withdrawal of the fastener from the opening.

18. A fastener assembly comprising:
a fastener comprising:
a body portion extending along a longitudinal axis and defining a first end and a second end,
a pair of tower legs extending from the body portion at the second end, each tower leg being resiliently deflectable relative to the longitudinal axis, and
at least one mating feature positioned on an inward-facing surface of each tower leg and configured to engage a corresponding seating portion of a rib tower of the second component;
a rib tower forming part of a second component, the rib tower including a seating portion configured to receive the mating features of the fastener; and
a first component defining an opening configured to receive the fastener and engage the locking projections,
wherein the fastener is configured to mechanically couple the first and second components together through engagement of the mating features with the rib tower and engagement of the locking projections with the first component.

19. The fastener assembly of claim 18, wherein the fastener is formed of a synthetic polymer or a semi-synthetic polymer.

20. A plastic fastener for coupling a first component and a second component, the plastic fastener comprising:
a body portion extending along a longitudinal axis and defining a first end and a second end;
a pair of tower legs extending from the body portion at the second end, each tower leg being resiliently deflectable relative to the longitudinal axis; and
at least one mating feature positioned on an inward-facing surface of each tower leg and configured to engage a corresponding seating portion of a rib tower of the second component,
wherein the mating feature is configured to facilitate insertion of the rib tower between the pair of tower legs and to resiliently engage the seating portion to mechanically retain the plastic fastener to the rib.
